(19) United States
(12) Patent Application Publication
(10) Pub. No.: US 2018/0089679 A1
(43) Pub. Date: Mar. 29, 2018

(54) PARTIALLY COMPLETED RESOURCE TRIGGERING AND COMPLETION SYSTEM

(71) Applicant: Bank of America Corporation, Charlotte, NC (US)

(72) Inventors: Joseph Benjamin Castinado, North Glenn, CO (US); Matthew Eugene Clark, Milpitas, CA (US)

(21) Appl. No.: 15/279,095

(22) Filed: Sep. 28, 2016

(51) Int. Cl. G06Q 20/40; H04L 29/06

(52) U.S. Cl. CPC G06Q 20/4014; G06Q 20/4012; G06Q 20/405; H04L 63/08

(57) ABSTRACT

Embodiments enable a remediation of a processing error by recognizing occurrence of the processing error, identifying one or more triggering events and, in response to the triggering event(s), remediating the processing error. This may be done by re-initiating the partially completed processing action from a partially completed position. Thus, embodiments monitor failed resource usage and remediate the failure by determining that the user attempted to use a resource to perform an action associated with a third party, determining that the attempt to use the resource to perform the action failed; determining that a trigger has occurred; and expediting a second attempt to perform the action.

### BACKGROUND

Often a user attempts to perform an action with a user device and the action is not completed. Therefore, systems are needed for monitoring failed resource usage and remediating failures.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the invention enable a remediation of a processing error by recognizing occurrence of the processing error, identifying one or more triggering events and, in response to the triggering event(s), remediating the processing error. This may be done by re-initiating the partially completed processing action from a partially completed position. Thus, the system provides technological benefits such as improvement of a processing system. Notably, if the present invention were not available, then, in order to be completed, the failed processing action would require initiation of a new processing action rather than re-implementing a partially completed processing action. In that sense, the present invention provides a technological improvement to processing efficiency.

Embodiments of the present invention address the above needs and/or achieve other advantages by providing systems, methods, and computer program products for monitoring failed resource usage and remediating the failure.

According to embodiments of the invention, the system includes a memory device storing computer executable code and a processing device to execute the computer executable code to cause the processing device to: determine that the user attempted to use a resource to perform an action associated with a third party; determine that the attempt to use the resource to perform the action failed; determine that a trigger has occurred; provide information related to the resource or the failed action to the third party; expedite a second attempt to perform the action, including receiving authentication information comprising the provided information from the user, the authentication information configured to authenticate an identity of the user; and authenticating the identity of the user based on the received authentication information; and, in response to authenticating the identity of the user, perform the action.

According to embodiments of the invention, a system includes a memory device storing computer executable code and a processing device to execute the computer executable code to cause the processing device to determine that the user attempted to use a user device to perform a transaction with a financial institution; determine that the attempt to use the user device to perform the transaction failed; determine that a predetermined triggering event has occurred; expedite a second attempt to perform the transaction, including receiving authentication information configured to authenticate an identity of the user; and authenticating the identity of the user based on the received authentication information; and, in response to authenticating the identity of the user, perform the transaction.

In some embodiments, the computer executable code is further to cause the processing device to provide information related to the user device or the failed transaction to the user and/or the financial institution. In some such embodiments, the received authentication information comprises the provided information.

In some embodiments, the received authentication information comprises a user device identifier configured to identify the user device.

In some embodiments, expediting the second attempt comprises receiving information related to the user's attempt to perform the transaction. In some such embodiments, the information comprises at least one of an amount, a check number, or a transaction number.

In some embodiments, the computer executable code is further to cause the processing device to, based on information related to the failed transaction, transmit a message to the user device configured to direct the user to a particular station or teller for expediting the second attempt to conduct the transaction. In some such embodiments, the computer executable code is further to cause the processing device to provide information related to the failed transaction to the station or teller for expediting the second attempt to conduct the transaction.

In some embodiments, the computer executable code is further to cause the processing device to provide information related to the user to the station or teller for expediting the second attempt to conduct the transaction or authenticating the identity of the user. In some such embodiments, the provided information comprises a photograph of the user and wherein authenticating the identity of the user comprises presenting the photograph of the user to the teller and receiving confirmation from the teller of the identity of the user.

In some embodiments, the trigger comprises completion of a second check deposit. In some embodiments, determining the trigger has occurred comprises determining a plurality of predetermined events have occurred.

According to embodiments of the invention, a computer program product configured for monitoring failed resource usage and remediating the failure includes a non-transitory computer readable medium having computer-executable instructions stored therein, the computer-executable instructions to cause a processing device to determine that the user attempted to use a user device to perform a transaction with a financial institution; determine that the attempt to use the user device to perform the transaction failed; determine that a predetermined triggering event has occurred; expedite a second attempt to perform the transaction, comprising receiving authentication information configured to authenticate an identity of the user; and authenticating the identity of the user based on the received authentication information; and, in response to authenticating the identity of the user, perform the transaction.

In some embodiments, the computer-executable instructions are further to cause a processing device to provide information related to the user device or the failed transaction to the user and/or the financial institution.

In some embodiments, the received authentication information comprises the provided information.

In some embodiments, the received authentication information comprises a user device identifier configured to identify the user device.

In some embodiments, expediting the second attempt comprises receiving information related to the user's attempt to perform the transaction.

In some embodiments, the information comprises at least one of an amount, a check number, or a transaction number.

In some embodiments, the computer-executable instructions are further to cause a processing device to transmit, based on information related to the failed transaction, a message to the user device configured to direct the user to a particular station or teller for expediting the second attempt to conduct the transaction. In some such embodiments, the computer-executable instructions are further to cause a processing device to provide information related to the failed transaction to the station or teller for expediting the second attempt to conduct the transaction.

According to embodiments of the invention, a computer-implemented method for monitoring failed resource usage and remediating the failure includes using a computer processor operating computer program code instructions stored in a non-transitory computer readable medium, wherein said computer program code instructions cause said computer processor to determine that the user attempted to use a user device to perform a transaction with a financial institution; determine that the attempt to use the user device to perform the transaction failed; determine that a predetermined triggering event has occurred; expedite a second attempt to perform the transaction, comprising receiving authentication information configured to authenticate an identity of the user; and authenticating the identity of the user based on the received authentication information; and, in response to authenticating the identity of the user, perform the transaction.

The following description and the annexed drawings set forth in detail certain illustrative features of one or more embodiments of the invention. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, wherein:

FIG. 1 is a block diagram of an environment in which systems operate according to embodiments of the present invention;

FIG. 2A is a flowchart illustrating a method 200A for partially completed resource triggering and completion according to embodiments of the invention;

FIG. 2B is a flowchart illustrating a method 200B for partially completed resource triggering and completion according to embodiments of the invention;

FIG. 3 is a flowchart illustrating a method 300 for authenticating a user and providing functionality to the authenticated user according to embodiments of the invention;

FIG. 4 is a flowchart illustrating a method 400 for completing a transaction according to embodiments of the invention;

FIG. 5 is a flowchart illustrating a method 500 for providing location based banking according to embodiments of the invention;

FIG. 6 is a flowchart illustrating a method 600 for authenticating the identity of the user according to embodiments of the invention; and

FIG. 7 is a flowchart illustrating a method 700 for providing transaction functionality according to embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Embodiments of the invention enable a remediation of a processing error by recognizing occurrence of the processing error, identifying one or more triggering events and, in response to the triggering event(s), remediating the processing error. This may be done by re-initiating the partially completed processing action from a partially completed position. Thus, the system provides technological benefits such as improvement of a processing system. Notably, if the present invention were not available, then, in order to be completed, the failed processing action would require initiation of a new processing action rather than re-implementing a partially completed processing action. In that sense, the present invention provides a technological improvement to processing efficiency.

In some embodiments, the processing error involves failure to complete transmission of all necessary data to a disparate system in order to complete an action. In other embodiments, the processing error involves a processor having a hardware or software discrepancy that results in introduction of inaccurate data into a processing event, thereby rending the event incomplete.

In other words, embodiments of the invention provide a system that monitors failed resource usage and remediates the failed usage by assisting a user to perform an action. The system includes a processing device configured for determining that the user attempted to use a resource to perform an action associated with a third party; determining that the attempt to use the resource to perform the action failed; determining that a user device of the user is located within a physical boundary; providing information related to the resource or the failed action to the third party; expediting a second attempt to perform the action including receiving authentication information comprising the provided information from the user, the authentication information configured to authenticate an identity of the user, and authenticating the identity of the user based on the received authentication information; and in response to authenticating the identity of the user, performing the action.

Various other embodiments of the invention provide for a partially completed resource triggering and completion system. Embodiments of the system recognize that a customer has partially completed an application or tried to make a mobile deposit that did not go through. The system may already have some data regarding the partially completed resource such as the check number, the amount, etc. Thus, the system may monitor for a variety of triggers to prompt the system to attempt to complete the transaction with the customer. Once the system recognizes that the user has successfully deposited another check, the system could re-attempt to deposit the initial check with the info it already has about the initial check and the user.

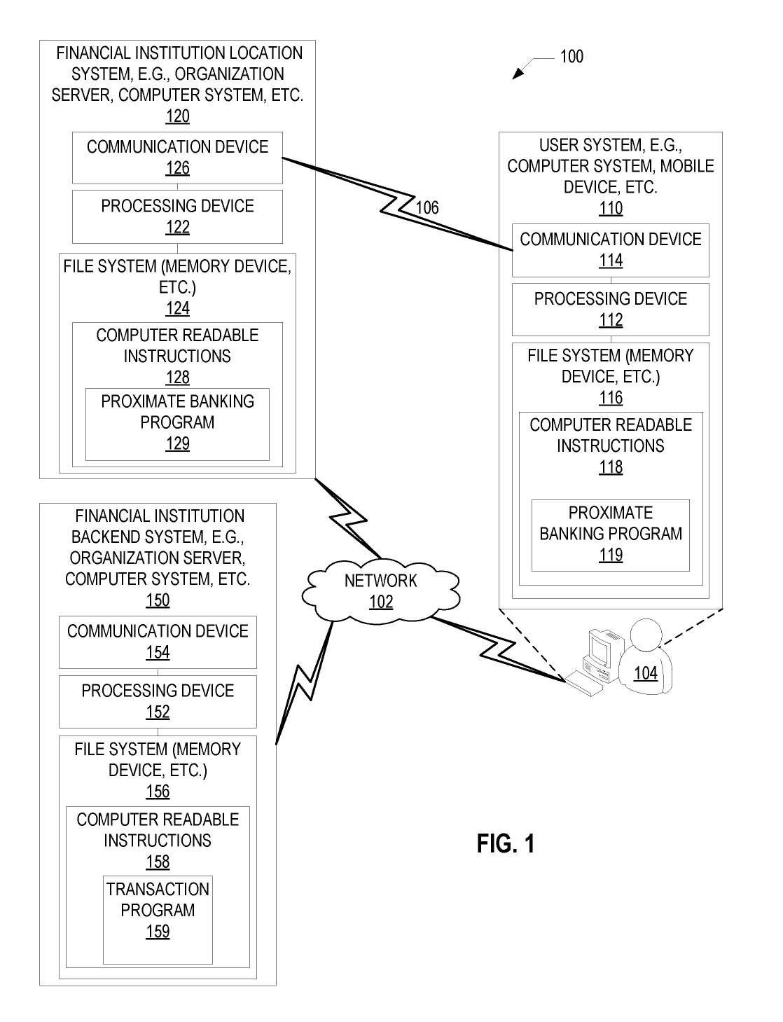

Referring concurrently now to FIG. 1, a block diagram of environment 100, in which systems operate according to embodiments of the present invention is shown. FIG. 1 illustrates an environment 100 in which the financial institution location system 120, the user system 110 and the financial institution backend system 150 interact over a network 102. Each of the systems 120 and 150 communicate over the network 102 with the user system 110. In some embodiments, one or more of the systems 110, 120, and/or 150 communicate directly with one another.

In the various embodiments, the user system 110 is a computer system, mobile device or other computing device used by a client 104 or other user to interact with an organization's online content and applications, such as by communicating with the financial institution location system 120. The user system 110 includes, in the embodiment shown, a processing device 112 communicatively coupled with a communication device 114 and a file system 116. The processing device, in some embodiments, is configured for controlling operation of the communication device 114 in order to communicate across the network 102, such as, for example, with the financial institution location system 120 and/or the financial institution backend system 150. The file system 116 is or includes a memory device or other memory configured for storing computer readable instructions 118 such as an operating system, applications, such as a browser and others, other computer program code and the like. In some embodiments, the computer readable instructions include a proximate banking program 119 configured for instructing the processing device 112 to perform one or more of the methods and/or steps discussed herein. The proximate banking program 119, in some embodiments, is configured for instructing the processing device 112 to communicate with the financial institution system, 120 and/or 150 either directly or over one or more external networks such that the user device may connect with a financial institution system to receive communications such as instructions and information about products and/or offers related to the customer's purpose in visiting the financial institution location and/or to begin and potentially complete a transaction. The processing device 112, of course, is configured for accessing and/or retrieving some or all the computer readable instructions 118 and executing some or all of them.

In one embodiment, for example, the network 102 is an intranet or other local area network (LAN) and the user system 110, the financial institution location system 120, and the financial institution backend system 150 are all part configured for communicating with one another across the intranet. In such an embodiment, the user system, when directed by the user 104 to access a particular intranet webpage, uses a browser program to navigate to the intranet webpage. The browser and/or the proximate banking program 119 then requests online interaction, such as webpage content, from the financial institution location system 120.

The financial institution location system 120, in some embodiments, is a server such as an organization server. In some embodiments, the financial institution location system 120 is maintained and/or owned by a financial institution such as a bank. In some such cases, the financial institution location system 120 is considered part of one or more backend systems of the bank. The financial institution location system 120 includes, in some embodiments, a processing device 122 communicatively coupled with a communication device 126 and a file system 124, such as a memory device or memory. The processing device 122 is configured for controlling operation of the communication device 126 for communicating over the network 102 such as with the user system 110 and/or the financial institution backend system 150. The file system 124 is configured for storing computer readable instructions 128, such as, for example, the proximate banking program 129, an operating system, other applications, other computer executable program code and the like. The proximate banking program 129 includes program code and/or instructions for performing one or more of the methods and/or method steps discussed herein. For example, in one embodiment, the proximate banking program 129 is configured for instructing the processing device 122 to communicate with the user device 110 either directly or over one or more external networks such that the user device may connect with the financial institution location system 120 to transmit communications such as instructions and information about products and/or offers related to the customer's purpose in visiting the financial institution location and/or to begin and potentially complete a transaction with the user of the user device 110. The processing device 122, of course, is configured to access and/or retrieve some or all the computer readable instructions 128 and execute some or all of them.

The financial institution backend system 150 is, in some embodiments, a server such as an organization server, a computer system, another computing device or the like. In some embodiments, the organization is a financial institution such as a bank and the financial institution backend system 150 is a financial institution server. In some instances, the financial institution backend system 150 is or is part of the bank's backend systems. The financial institution backend system 150, in some embodiments, includes a processing device 152 communicatively coupled with a communication device 154 and a file system 156. The processing device 152 is typically configured to control the communication device for communicating across the network 102 with one or more of the other systems, such as the financial institution location system 120 and/or the user system 110. The file system 156 is configured for storing computer readable instructions such as an transaction program 159, an operating system, other computer executable program code, applications and the like. The processing device 152 is configured for accessing and/or retrieving some or all the computer readable instructions 158 from the file system 156 and executing some or all of them. In some embodiments, for example, the transaction program 159 includes program code configured to instruct the processing device 152 communicate with the user device 110 either directly or over one or more external networks such that the user device may connect with the financial institution backend system 150 to transmit communications such as instructions and information about products and/or offers related to the customer's purpose in visiting the financial institution location and/or to begin and potentially complete a transaction with the user of the user device 110.

In some such embodiments, the financial institution location system and the financial institution backend system share components, such as, for example, processing device 122 is the same device as processing device 152. Likewise, in some embodiments, file system 126 is the same system as file system 156. In various embodiments, the computer readable instructions on a server (not shown) that includes only one “proximate banking program” including both the instructions of the proximate banking program 129 and the instructions of the transaction program 159. In other embodiments, the computer readable instructions of the server include multiple distinct programs, such as, for example, a distinct proximate banking program 129 and a distinct transaction program 159.

Embodiments of the invention provide for a system that monitors failed (or paused/abandoned) resource usage and remediates the failure (or re-initiates the paused/abandoned usage). In some embodiments, the system determines the location of the user based on the user device of the user. The location may be done by accessing the GPS coordinates of the user device, recognizing the cell station with which the user device is connected, recognizing the location of a WiFi source with which the user device is connected and/or others. Further, the system may receive information from the user device that the user attempted to perform an action (e.g., a transaction). For example, the user may attempt to scan a check in order to submit its digital image for mobile deposit into the user's account. If the process fails for some reason (or if the user pauses the process such as inputting some but not all the necessary information in an application for a product), for example, if the user device's Internet connection is lost, then the user device may already have some information about the failed transaction. In the example of the mobile check deposit, the user device may have an image of a check that may or may not have all the necessary information from the check to make a deposit. The user device may also have the capability to extract the important data from the check. Thus, the user device may be able to provide some or all the information necessary to complete the previously attempted transaction to the financial institution system. The system may then proceed with the deposit of the check automatically and may request confirmation from the user (either through the user device or in person through a station such as an ATM or through a teller) that the user desires to deposit the check.

In some embodiments, the system pushes the user to a particular station and/or teller. This may be done in order to steer the user to the This may be done by determining the nature of the failed transaction and determining which station/teller is best suited to complete the failed transaction for the user. Once this is done, the system may transmit to the user device of the user an indication of which station/teller for the user to use. In some embodiments, in order to authenticate the user to the station/teller, the user's photograph and/or other information about the user may be presented to the teller so that the teller may manually confirm the user's identity. In some embodiments, the user may take a selfie photograph and provide it to the system for use as an authentication photograph.

In some embodiments, when a user attempts and fails to complete a transaction using the user device, the user device may be configured to generate (or retrieve from a list of pre-generated identifiers) a unique failed transaction identifier. In other embodiments, the user device may communicate with a financial institution system and request a failed transaction identifier to be sent to the user device. In some cases, some of the data necessary to complete a transaction is transmitted from a user device to a financial institution system but the transmission may be lacking necessary information. In such a case, once any re-transmissions attempts have been exhausted, the FI system may transmit a failed transaction identifier (or instructions to generate/retrieve a failed transaction identifier) to the user device. The user device may then present the failed transaction identifier to the user in some embodiments.

The failed transaction identifier may be used both to authenticate the identity of the user and/or to provide the financial institution location (either branch or ATM) the ability to retrieve any data regarding the failed transaction from the financial institution systems. In some embodiments, the failed transaction identifier is sufficient to authenticate the identity of the user so that the user may not be required to provide any additional form(s) of identification.

In some embodiments, the system may transmit alerts to the user device requesting the user verify signatures provided at a merchant's point of sale. In other embodiments, the system may transmit notifications regarding various bank services that are being provided for the user.

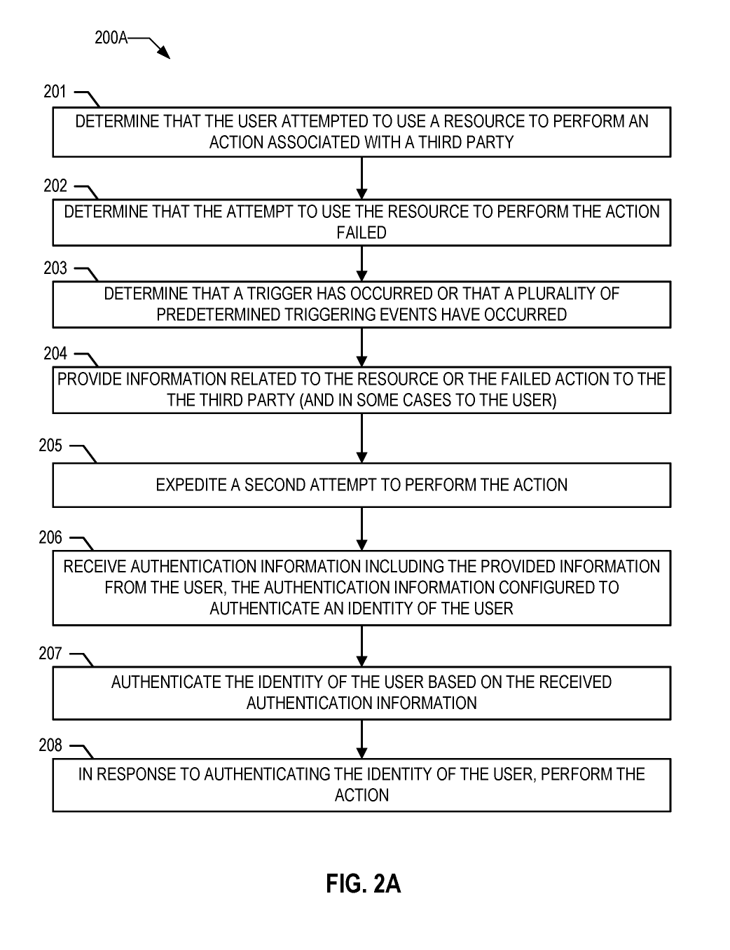

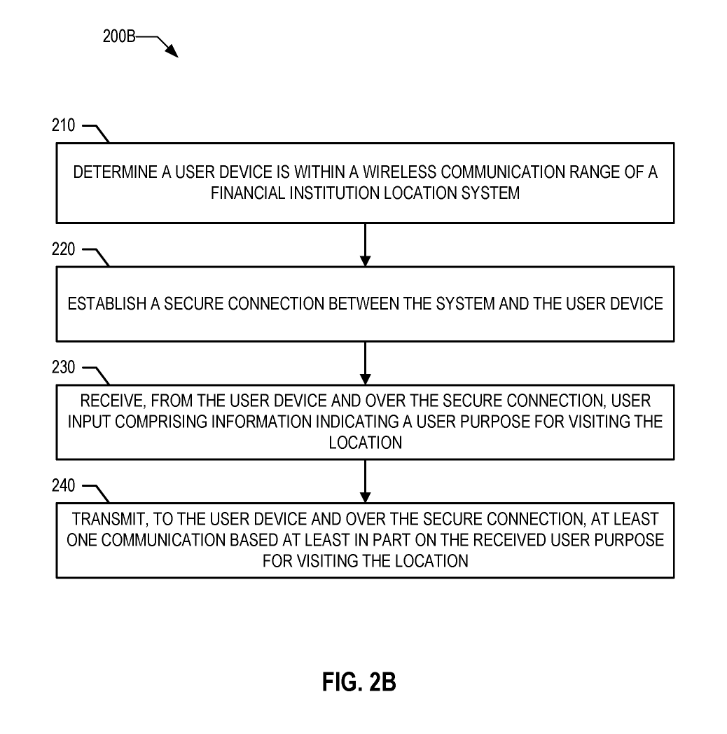

Referring now to FIG. 2A, a flowchart illustrates a method 200A for partially completed resource triggering and completion according to embodiments of the invention. The first step, as represented by block 201, is to determine that the user attempted to use a resource to perform an action associated with a third party. In some embodiments, the resource is the user device and the action is a transaction with a financial institution. The next step, as represented by block 202, is to determine that the attempt to use the resource to perform the action has failed.

The next step, as represented by block 203, is to determine that a trigger has occurred or that a plurality of predetermined triggering events have occurred. In some embodiments, the user device of the user is located within a physical boundary, such as within a financial institution physical location (i.e., a branch). In other embodiments, the trigger may include or consist of determining that a transaction has been successfully completed, such as the successful completion of the deposit of a check. In some embodiments, for example, the successful deposit of a check is performed through a mobile deposit, and once the mobile deposit has been completed, the system initiates a communication to the mobile device of the user indicating that the user has an incomplete action that may now be completed. Thus, the system may initiate a partially completed resource triggering and completion process. In some embodiments, more than one triggering event must take place before the process moves to the next step, for example, moving to step(s) 204, 205, 206, 207 and/or 208, each discussed below. For example, in some embodiments, two or more transactions must be completed successfully before triggering the partially completed resource completion process. As a specific example, in some cases, a mobile transaction as well as another transaction, whether mobile or otherwise, must be completed to constitute the trigger.

In some embodiments, the system includes a set of predetermined criteria and/or rules for governing the implementation determination of triggering events and initiation of the partially completed resource completion process. For example, a set of rules may dictate that a triggering event must occur from a recognized device of the customer, that a triggering event must occur from a multi-factor authentication transaction, that a triggering event must occur from an in-person transaction at a financial institution physical location and/or otherwise.

In some embodiments, some or all the triggering events must occur in time proximity to the partially completed resource process, that is, the process to completed the partially completed action (e.g., a mobile deposit) must occur within a predetermined time of the triggering events. For example, if a qualifying triggering event of a completed mobile deposit occurs, then the customer may have one (1) hour to complete a previous partially completed transaction. Such embodiments may require that, in order to access a partially completed action, the customer must perform the triggering event(s); whereas, in other embodiments, the customer need not necessarily perform the triggering event(s) in order to complete the partially completed action. Thus, in some embodiments, the triggering event(s) serve as a necessary threshold to complete the partially completed action, whereas in other embodiments, the triggering events merely serve to trigger a reminder that the partially completed action may be completed.

Thus, in various embodiments, predetermined rules/criteria dictating qualifying triggering event(s), may dictate the timing, location, type, number, authentication level, etc. of the triggering events. For example, a number of transactions may be required to be completed before initiating a notification to the user reminding the user of the partially completed action. Similarly, a threshold amount of a partially completed transaction may be required for it to be included within this program. In some cases, a cumulative threshold amount of transactions must be completed before completion of the partially completed action is triggered.

A partially completed action or a triggering event may be or include various actions, transactions, events or the like. For example, an attempt to add a new payee or performing some other action within online banking or a mobile application may be a partially completed action or a triggering event. Similarly, an incomplete online mortgage application may be a partially completed action or a completed online mortgage application may be a triggering event. Further, attempting to send a person to person payment may be a partially completed action or completing a person to person payment may be a triggering event.

The next step, as represented by block 204, is the optional step of providing information related to the resource or the failed action to the third party and/or to the user. This information may include, for example, a user device identifier, a user identifier, information regarding the transaction or otherwise. In other embodiments, as discussed above, the user device may provide its identifier, the failed transaction identifier, a user identifier or other information to the FI system, rather than the FI system providing some or all that information to the user (through the user device or otherwise, such as through another device).

The next step, as represented by block 205, is to expedite a second attempt to perform the action. This step 205 may include one or more sub-steps, such as sub-step 206, which is receiving authentication information including the provided information from the user. For example, if the FI system provides a failed transaction identifier to the user device, then the user may supply the failed transaction identifier when the user visits the financial institution for authentication of the identity of the user. Sub-step 207 is to authenticate the identity of the user based on the received authentication information. This authentication information may be or include a user identifier, a user device identifier, a failed transaction identifier and/or the like.

The final step, as represented by block 208, is to perform the action (such as completing the transaction) in response to authenticating the identity of the user.

Referring now to FIG. 2B, a flowchart illustrates a method 200B for partially completed resource triggering and completion according to embodiments of the invention. First, as represented by block 210, a processing device, such as any of processing devices 122, 152 and/or 162 discussed above, determines a user device is within a range of a financial institution location. In some embodiments, the range is defined by the wireless communication range of a financial institution location system located in the financial institution location. In other embodiments, the range is defined by a predetermined radius or perimeter outside a financial institution location. The user's location may be determined using GPS or otherwise by the user device.

When the user device is within the range, a secure connection is established between a financial institution system and the user device, as represented by block 220. This connection may be made based on the user device being recognized by a financial institution location system 120 maintaining a wireless communication network that recognizes the presence of the user device. The connection, in other embodiments, may be made based on the user device having an application running that recognizes its location is proximate a financial institution location based on GPS or some other location determination functionality and then connects the user device over another wireless network, such as by using the user device's cellular data connection, with a financial institution backend system 150.

The established connection, in some embodiments, is a secure connection. The connection may need to be secured for sensitive information such as account information or otherwise to be transmitted across the connection. In some embodiments, the information that is transmitted is encrypted before being transmitted so as to further increase security of the transmitted information.

The next step, as represented by block 230, is for the system to receive, from the user device and over the secure connection, user input. The user input may include information indicating the user's purpose for visiting the financial institution location. This user information is received from the user in response to a prompt requesting the user communicate the user's intentions in visiting the financial institution location. The user's input may be received in a variety of ways, such as by capturing spoken word of the user, receiving textual input from the user or other touch-based input, retrieving predetermined user preferences or otherwise. In some embodiments, the user input is received in response to one or more questions and/or options presented to the user for consideration. For example, in one embodiment, the application presents a list of the most common reasons a user visits a financial institution location to the user for the user's selection of their purpose in visiting. If the user's purpose is not listed, the user may be given an option to select that none of the available options match the user's purpose in visiting. The user may then be given another list of the next most likely reasons for the user visiting or the user may have an option to provide specific input, audibly or textually, for the user's purpose in visiting.

The next step, as represented by block 240, is for the system to transmit, to the user device and over the secure connection, at least one communication based at least in part on the received user purpose for visiting the financial institution location.

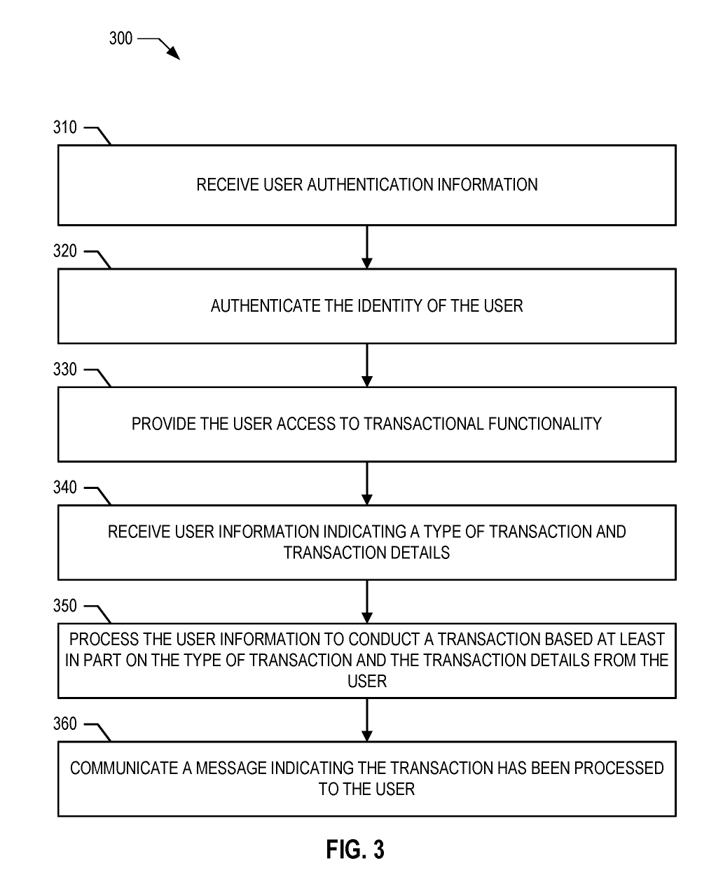

Referring now to FIG. 3, a flowchart illustrates a method 300 for authenticating a user and providing functionality to the authenticated user in accordance with embodiments of the invention. One or more of the steps of method 300 may be performed in conjunction with one or more of the steps discussed above with reference to FIG. 2. The first step of method 300 is for the system to receive user authentication information such as a username and password or otherwise. The authentication information may be the same information the user uses to log into an online banking website maintained by the financial institution. In step 320, the system authenticates the identity of the user, and in step 330, the system provides the user access to transactional functionality, such as performing a transfer of funds, depositing a check, or the like.

The next step, as represented by block 340, is to receive information indicating a type of transaction and transaction details from the user. For example, the user may indicate that the user wishes to deposit a check electronically and indicate the destination account for the funds. In step 350, the system processes the user information to conduct the transaction based at least in part on the type of transaction and the transaction details received from the user. At step 360, the system communicates, to the user, a message indicating the transaction has been processed.

In some instances, the user will not complete a transaction using the user device but rather, will merely receive information over the user device providing the user instructions for completing a transaction or other information useful to the user given the user's purpose for coming to the location.

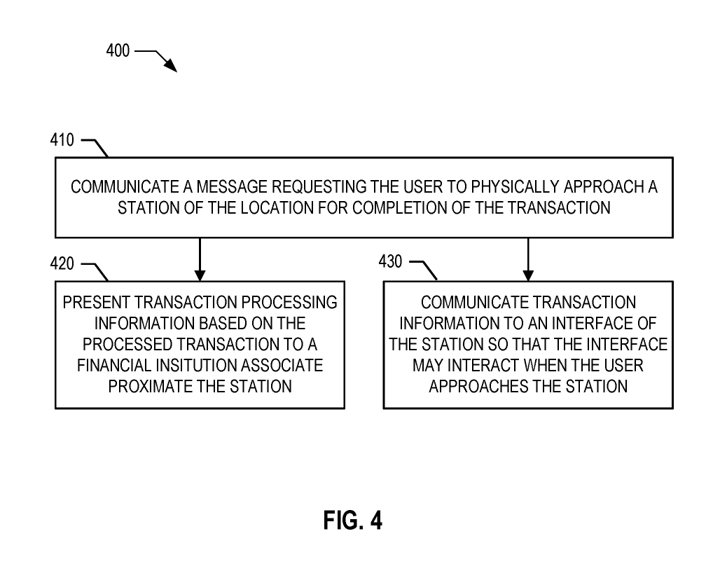

Referring now to FIG. 4, a method 400 for completing a transaction according to embodiments of the invention is illustrated. One or more of the steps of method 400 may be performed in conjunction with one or more of the steps of one or more of the other methods discussed herein. The first step of method 400 is for the system to communicate a message to the user requesting the user to physically approach a station of the location for completion of the transaction. The station may be a teller located within the financial institution location, such as behind a desk or may be a teller at a drive-through window or otherwise. The next step, represented by block 420, is for the system to present transaction processing information based on the processed transaction to a financial institution associate proximate the station. Alternatively or in addition to step 420, the system may perform step 430, which is to communicate transaction information to an interface of the station so that the interface may interact when the user approaches the station. The interface may be a display and may include one or more input devices and/or one or more additional output devices for interacting with the user. The station, either by way of a financial institution associate and/or an interface may assist the user in conducting his or her business. Information regarding the user's purpose may be forwarded to the station so that the associate and/or the interface may prepare any documentation necessary to move forward with the business or otherwise prepare for the user to interact with the station.

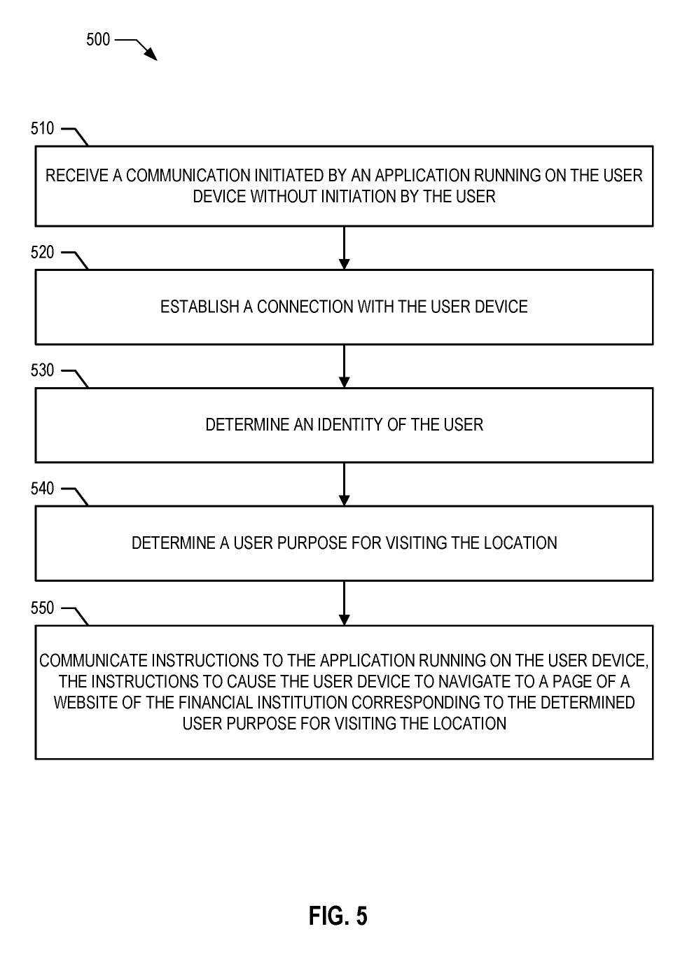

According to some embodiments of the invention, a user device may run an application in its background that recognizes when the user device approaches a financial institution location and provides a notification to the user. Referring now to FIG. 5, a method 500 for providing location based banking according to embodiments of the invention is illustrated. The first step, represented by block 510, is for a financial institution system to receive a communication initiated by an application running on the user device. The application runs on the user device and provides the notification in response to recognizing that the user device is approaching or is co-located with a financial institution location. The communication may be an alert to the user such as via SMS messaging such as text messaging, email, or other device-based alert such as a pop-up visual alert, a vibratory alert, an audible alert and/or the like.

The next step, as represented by block 520, is to establish a connection with the user device. The connection may be established directly with the financial institution location system, such as over a WIFI network or other local connection channel or may be established through an external network such as by using the user device's cellular data network. In a case where the connection is made over an external network, the user device may connect with the financial institution location system, which is located in or proximate the financial institution location or some other system maintained by the financial institution, such as a financial institution backend system, which is typically not collocated with the financial institution location.

The next step, represented by block 530, is to determine an identity of the user. This may be done by receiving user authentication information such as a username and password or may be done in other ways, such as by receiving a token or device ID unique to the user device. The next step, represented by block 540, is to determine a user purpose for visiting the location. As discussed above, the user's purpose in visiting the location may be inputted by the user in response to a prompt and may be in response to one or more questions inquiring details about the user's purpose in visiting the location. In some embodiments, where it is determined that the user device is traveling in proximity of a financial institution location or traveling toward a financial institution location or both, the user device may prompt the user to confirm that the user is traveling to the financial institution location, and then, in some embodiments, may proceed to prompt the user to input the user's purpose in traveling to the financial institution location. The next step, represented by block 550, is to communicate instructions to the application running on the user device. The instructions may cause the user device to navigate to a page of a website of the financial institution corresponding to the determined user purpose for visiting the location. For example, the user device may navigate to an online banking website page dedicated to accepting an electronic deposit or transferring funds. In other instances, the user device may navigate to a page of the financial institution providing information about a product or offer.

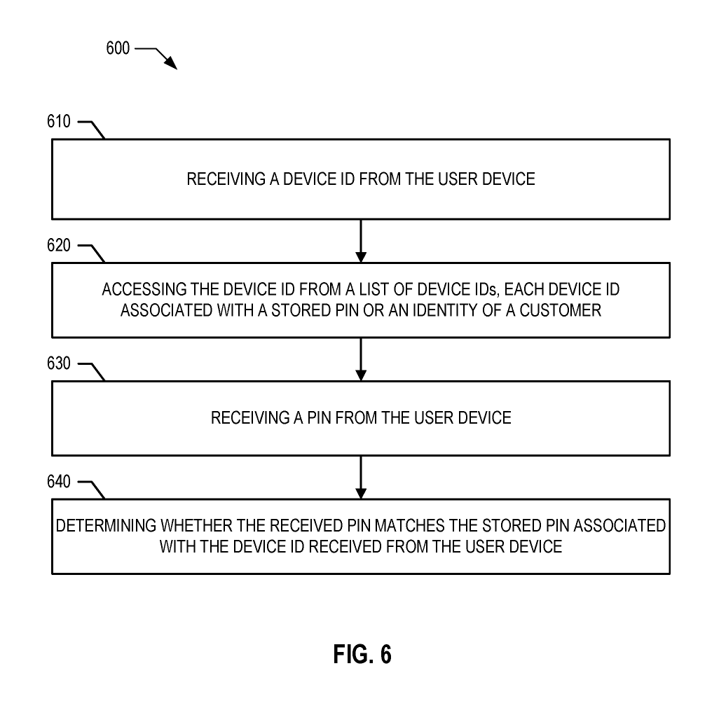

Referring now to FIG. 6, a method 600 for authenticating the identity of the user is illustrated. This method 600 involves an embodiment where the authentication is accomplished at least in part by verification of a token and/or device ID unique to the user device, and typically associated with the user of the user device. The first step, represented by block 610 is the system receiving a device ID or token unique to the user device and/or the user from the user device. The application running on the user device may provide the device ID or token automatically and in response to recognizing that the user device is location at or approaching the financial institution location.

In some embodiments, the next step, represented by block 620, is the system accessing the device ID or the token from a list of device IDs or tokens, where each device ID or token is associated with a stored PIN or other supplementary authentication mechanism. In some embodiments, such as when secondary or supplemental authentication is not required, the system also, or alternatively, accesses the identity of the customer/user and the user is considered to be authenticated. In a case where secondary or supplemental authentication is required, as represented by block 630, the system may receive a PIN or other secondary authentication mechanism from the user device. The user device may, of course, receive the PIN from user input. The next step, represented by block 640, is determining whether the received PIN or other secondary authentication mechanism matches a stored PIN associated with the device ID or token received from the user device. In this regard, the PIN input by the user provides secondary authentication for embodiments where the user device may automatically connect with the financial institution system and provide preliminary authentication, such as by providing a device ID to a financial institution system.

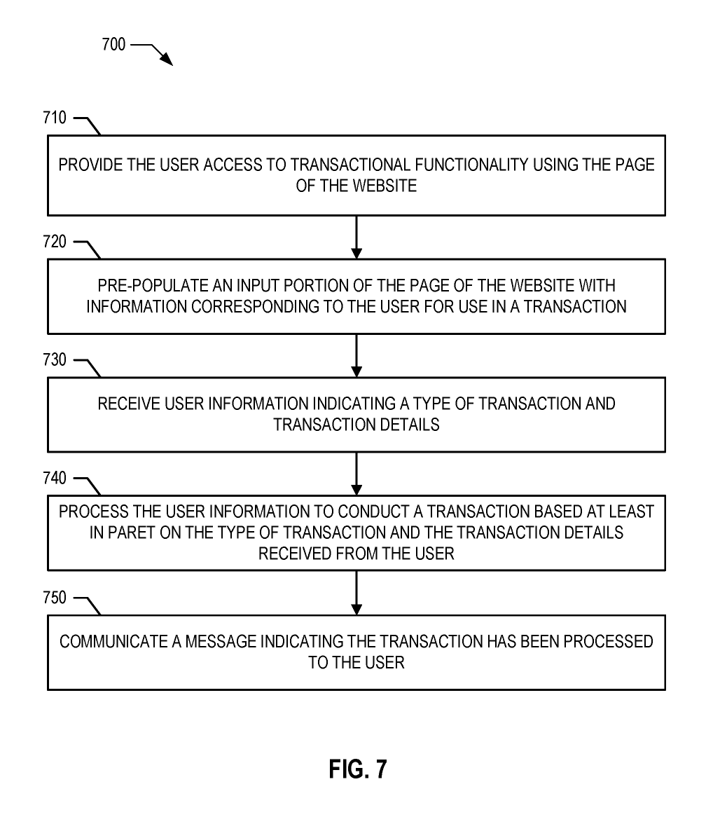

Referring now to FIG. 7, a method 700 for providing transaction functionality according to embodiments of the invention is illustrated. The first step, represented by block 710, is to provide the user access to transactional functionality using the page of the website to which the user was directed, such as in step 550 of FIG. 5. The next step, represented by block 720, is to pre-populate an input portion of the page of the website or other page, form or application, with information corresponding to the user for use in a transaction. For example, the user may be applying for a credit card and the application for the credit card may be pre-populated by the system with information corresponding to the user. The next step, represented by block 730, is to receive user information indicating a type of transaction and transaction details. The next step, represented by block 740, is to process the user information to conduct a transaction based at least in part on the type of transaction and the transaction details received from the user. Finally, the last step, represented by block 750, is to communicate a message indicating the transaction has been processed to the user.

In summary, various embodiments of the invention are directed to a system that provides assistance to a user having a user device proximate a financial institution location by receiving a communication initiated by an application running on the user device without initiation by the user; establishing a connection with the user device; determining an identity of the user; determining a user purpose for visiting the location; and communicating instructions to the application running on the user device, the instructions to cause the user device to navigate to a page of a website of the financial institution corresponding to the determined user purpose for visiting the location. In some embodiments, the identity of the user is determined by determining whether a received PIN matches a stored PIN associated with a device ID received from the user device.

Various other embodiments of the invention provide for a partially completed resource triggering and completion system. Embodiments of the system recognize that a customer has partially completed an application or tried to make a mobile deposit that did not go through. The system may already have some data regarding the partially completed resource such as the check number, the amount, etc. Thus, the system may monitor for a variety of triggers to prompt the system to attempt to complete the transaction with the customer. Once the system recognizes that the user has successfully deposited another check, the system could re-attempt to deposit the initial check with the info it already has about the initial check and the user.

In various embodiments, once a triggering event or triggering events trigger the system to attempt to complete the partially completed action, the system may send the user a notification or multiple notifications indicating the user has a partially completed action. In some cases, the notification(s) may include information about the partially completed action and/or information or link(s) to re-initiate completion of the partially completed action. In some embodiments, the opportunity for the user to re-initiate the partially completed transaction times out. This may be based on a variety of baselines, for example, re-initiation may be disabled a certain period of time from when one or more notifications are sent to the user. In other cases, re-initiation may be disabled a certain period of time from initial access to the partially completed action by the user (i.e., when the user initially attempted to complete the action but the action remained incomplete).

In various embodiments, a triggering event or events may be or include one or more actions in an online banking application or a mobile application. For example, a user logging-in to online banking session or mobile application may constitute a triggering event for the system. Other triggers may be or include the filing of a claim. For example, a user may file a claim or initiate a claim that the user was performing a transaction at an ATM and never received the expected amount of cash from the ATM. The initiation of this claim may serve as a trigger for the system to re-initiate the partially completed action (i.e., the ATM withdrawal transaction) by notifying the user of the opportunity to complete the transaction and providing information about how the user may complete the transaction.

Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

As used herein, unless specifically limited by the context, the term “transaction” may refer to a purchase of goods and/or services (collectively referred to herein as “products”), a withdrawal of funds, an electronic transfer of funds, a payment transaction, a credit transaction, a PIN change transaction or other interaction between a cardholder and the bank maintained a bank account owned by the cardholder. As used herein, a “bank card” refers to a credit card, debit card, ATM card, check card, or the like, or other payment device such as, but not limited to, those discussed above that are not cards. An “account” or “bank account” refers to a credit account, debit account, deposit account, demand deposit account (DDA), checking account, budgeting account or the like. Although the phrases “bank card” and “bank account” include the term “bank,” the card or payment device need not be issued by a bank, and the account need not be maintained by a bank and may instead be issued by and/or maintained by other financial institutions.

As used herein, a “processing device” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities.

As used herein, a “communication device” generally includes a modem, server, transceiver, and/or other device for communicating with other devices directly or via a network, and/or a user interface for communicating with one or more users. As used herein, a “user interface” generally includes a display, mouse, keyboard, button, touchpad, touch screen, microphone, speaker, LED, light, joystick, switch, buzzer, bell, and/or other user input/output device for communicating with one or more users.

As used herein, a “memory device” or “memory” generally refers to a device or combination of devices including one or more forms of non-transitory computer-readable media for storing instructions, computer-executable code, and/or data thereon. Computer-readable media is defined in greater detail herein below. It will be appreciated that, as with the processing device, each communication interface and memory device may be made up of a single device or many separate devices that conceptually may be thought of as a single device.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor/processing device may be “configured to” perform a certain function in a variety of ways, including, for example, by having one or more general-purpose circuits perform the function by executing particular computer-executable program code embodied in computer-readable medium, and/or by having one or more application-specific circuits perform the function.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

To supplement the present disclosure, this application further incorporates entirely by reference the following commonly assigned patent application: U.S. patent application Ser. No. ______ for “PARTIALLY COMPLETED RESOURCE GEOGRAPHIC TRIGGERING AND REMEDIATION SYSTEM”, filed Sep. 28, 2016.

What is claimed is:

1. A system for monitoring failed resource usage and remediating the failure, the system comprising:
a memory device storing computer executable code;
a processing device to execute the computer executable code to cause the processing device to:
determine that the user attempted to use a resource to perform an action associated with a third party;
determine that the attempt to use the resource to perform the action failed;
determine that a trigger has occurred;
provide information related to the resource or the failed action to the third party;
expedite a second attempt to perform the action, comprising:
receiving authentication information comprising the provided information from the user, the authentication information configured to authenticate an identity of the user; and
authenticating the identity of the user based on the received authentication information; and
in response to authenticating the identity of the user, perform the action.

2. A system for monitoring failed resource usage and remediating the failure, the system comprising:
a memory device storing computer executable code;
a processing device to execute the computer executable code to cause the processing device to:
determine that the user attempted to use a user device to perform a transaction with a financial institution;
determine that the attempt to use the user device to perform the transaction failed;
determine that a predetermined triggering event has occurred;
expedite a second attempt to perform the transaction, comprising:
receiving authentication information configured to authenticate an identity of the user; and
authenticating the identity of the user based on the received authentication information; and
in response to authenticating the identity of the user, perform the transaction.

3. The system of claim 2, wherein the computer executable code is further to cause the processing device to:
provide information related to the user device or the failed transaction to the user and/or the financial institution.

4. The system of claim 3, wherein the received authentication information comprises the provided information.

5. The system of claim 2, wherein the received authentication information comprises a user device identifier configured to identify the user device.

6. The system of claim 2, wherein expediting the second attempt comprises receiving information related to the user's attempt to perform the transaction.

7. The system of claim 6, wherein the information comprises at least one of an amount, a check number, or a transaction number.

8. The system of claim 2, wherein the computer executable code is further to cause the processing device to:
based on information related to the failed transaction, transmit a message to the user device configured to direct the user to a particular station or teller of a financial institution location for expediting the second attempt to conduct the transaction.

9. The system of claim 8, wherein the computer executable code is further to cause the processing device to:
provide information related to the failed transaction to the station or teller for expediting the second attempt to conduct the transaction.

10. The system of claim 8, wherein the computer executable code is further to cause the processing device to:
provide information related to the user to the station or teller for expediting the second attempt to conduct the transaction or authenticating the identity of the user.

11. The system of claim 10, wherein the provided information comprises a photograph of the user and wherein authenticating the identity of the user comprises presenting the photograph of the user to the teller and receiving confirmation from the teller of the identity of the user.

12. The system of claim 2, wherein the trigger comprises completion of a second check deposit.

13. The system of claim 2, wherein determining the trigger has occurred comprises determining a plurality of predetermined events have occurred.

14. A computer program product configured for monitoring failed resource usage and remediating the failure, the computer program product comprising a non-transitory computer readable medium comprising computer-executable instructions stored therein, the computer-executable instructions to cause a processing device to:
determine that the user attempted to use a user device to perform a transaction with a financial institution;
determine that the attempt to use the user device to perform the transaction failed;
determine that a predetermined triggering event has occurred;
expedite a second attempt to perform the transaction, comprising:
receiving authentication information configured to authenticate an identity of the user; and
authenticating the identity of the user based on the received authentication information; and
in response to authenticating the identity of the user, perform the transaction.

15. The computer program product of claim 14, the computer-executable instructions are further to cause a processing device to:
provide information related to the user device or the failed transaction to the user and/or the financial institution.

16. The system of claim 15, wherein the received authentication information comprises the provided information.

17. The system of claim 14, wherein the received authentication information comprises a user device identifier configured to identify the user device.

18. The system of claim 14, wherein expediting the second attempt comprises receiving information related to the user's attempt to perform the transaction.

19. The system of claim 18, wherein the information comprises at least one of an amount, a check number, or a transaction number.

20. A computer-implemented method for monitoring failed resource usage and remediating the failure, the method comprising:
using a computer processor operating computer program code instructions stored in a non-transitory computer readable medium, wherein said computer program code instructions cause said computer processor to:
determine that the user attempted to use a user device to perform a transaction with a financial institution;
determine that the attempt to use the user device to perform the transaction failed;
determine that a predetermined triggering event has occurred;
expedite a second attempt to perform the transaction, comprising:
receiving authentication information configured to authenticate an identity of the user; and
authenticating the identity of the user based on the received authentication information; and
in response to authenticating the identity of the user, perform the transaction.
